(19) United States
(12) Patent Application Publication
(10) Pub. No.: US 2013/0196683 A1
(43) Pub. Date: Aug. 1, 2013

(54) METHOD FOR POSITIONING AND APPARATUS FOR PERFORMING THE SAME

(71) Applicant: Electronics and Telecommunications Research In, Daejeon (KR)

(72) Inventors: Jae Young AHN, Daejeon (KR); Jae Kyun KWON, Daegu (KR); Kyungsu YUN, Daegu (KR); Rimhwan LEE, Gyeongbuk (KR)

(73) Assignee: Electronics and Telecommunications Research Institute, Daejeon (KR)

(21) Appl. No.: 13/724,784

(22) Filed: Dec. 21, 2012

(30) Foreign Application Priority Data
Dec. 22, 2011 (KR) 10-2011-0140534
Feb. 29, 2012 (KR) 10-2012-0021357
Dec. 20, 2012 (KR) 10-2012-0149655

(51) Int. Cl. H04W 24/00

(52) U.S. Cl. CPC H04W 24/00
USPC 455/456.1

(57) ABSTRACT

Disclosed are a positioning method and an apparatus for performing the same. The positioning method includes performing positioning with respect to a node to be positioned based on signals transmitted from a plurality of transmission nodes, generating reliability information for each channel link between the plurality of transmission nodes and the node to be positioned, and again performing positioning with respect to the node to be positioned based on position information of the node to be positioned that is acquired by performing positioning and the reliability information when a predetermined positioning completion condition is not satisfied. Therefore, it is possible to improve positioning accuracy.

### CLAIM FOR PRIORITY

This application claims priority to Korean Patent Application Nos. 10-2011-0140534 filed on Dec. 22, 2011, 10-2012-0021357 filed on Feb. 29, 2012, and 10-2012-0149655 filed on Dec. 20, 2012.

### BACKGROUND

1. Technical Field

Example embodiments of the present invention relate in general to positioning technology and more specifically to a positioning method that may improve positioning accuracy of a node to be positioned, and an apparatus for performing the same.

2. Related Art

Wireless positioning technology is technology for measuring positions of nodes whose positions are not fixed, like mobile terminals, and a variety of methods for improving positioning performance have been proposed.

In outdoor environments, Global Positioning System (GPS) provides the most accurate positioning performance, but GPS cannot be used in environments where the number of satellites that ensure line-of-sight (LOS) is limited, such as indoor environments, urban areas, forests, and the like. In order to this problem, a variety of alternative positioning systems, such as a method of using a mobile communication network and a method of using a Wireless Local Area Network (WLAN), have been developed, but there is a limit to ensuring satisfactory positioning performance.

The positioning methods used in GPS or the alternative positioning systems may generally use nodes whose positions are learned in advance, but in most cases these nodes are fixed. For example, in a case of downlink positioning in the mobile communication system, a transmission node whose position is learned in advance, such as a base station or the like, is used for positioning, and a node to be positioned may be a reception node, such as a mobile terminal or the like.

Meanwhile, a case in which information such as a distance, an angle, or the like between the transmission node and the reception node is used is referred to as a range-based positioning method, and as representative technologies, Time Of Arrival (TOA), Time Difference Of Arrival (TDOA), Angle Of Arrival (AOA), Delay Spread Of Arrival (DSOA), Received signal strength Of Arrival (ROA), and the like may be given.

In addition, a positioning method of using other information or other methods different from information such as the distance, the angle, or the like between the transmission node and the reception node is referred to as a range-free positioning method, and the representative technologies, Approximate Point-In-Triangulation (APIT), DV-Hop, centroid, fingerprint, RFPM: RF pattern matching (RFPM) method, and the like may be given.

In this manner, a variety of positioning methods may be used according to each system environment, and advantages and disadvantages may exist for each of the positioning methods.

In particular, a positioning method using a mobile communication network to which the range-based positioning method is mainly applied can use infrastructure facilities, and has emerged as the most viable alternative positioning system due to its advantages in secondary service processing.

However, in the range-based positioning method, transmission and reception terminals which are used in positioning are affected by other transmission and reception systems due to characteristics of a mobile communication system that re-uses frequencies. In addition, in the range-based positioning method, radio wave signals may be reflected, diffracted, or scattered during propagation, and therefore propagation delay such as nonlinear path attenuation, near-far effect, fading, or the like may occur, resulting in a reduction in reliability of the positioning.

The above-described problems of the range-based positioning method may not be overcome for positioning performance even though a channel link for mobile communications is in a superior state. That is, the range-based positioning system for complementing and solving the problems of GPS requiring LOS may have the best positioning performance when LOS is ensured.

Accordingly, when performing wireless positioning using a mobile communication network, a method for selecting a transmission node having LOS or using a channel link having high reliability is required in order to improve the positioning performance.

In addition, when LOS between transmission and reception nodes is not ensured, a method of performing positioning using a link closest to LOS is required.

### SUMMARY

Accordingly, example embodiments of the present invention are provided to substantially obviate one or more problems due to limitations and disadvantages of the related art.

Example embodiments of the present invention provide a positioning method that can improve positioning accuracy.

Example embodiments of the present invention also provide a positioning apparatus that can improve positioning accuracy.

In some example embodiments, a positioning method includes: performing positioning with respect to a node to be positioned based on signals transmitted from a plurality of transmission nodes; generating reliability information for each channel link between the plurality of transmission nodes and the node to be positioned; and again performing positioning with respect to the node to be positioned based on position information of the node to be positioned that is acquired by performing positioning and the reliability information when a predetermined positioning completion condition is not satisfied.

Here, the performing of the positioning may include generating at least one subset in accordance with predetermined criteria with respect to the plurality of transmission nodes, estimating distance information or angle information between the plurality of transmission nodes included in each of the at least one subset and the node to be positioned, and determining a position of the node to be positioned for each of the at least one subset based on the estimated distance or angle information.

Here, the generating may include calculating an error with respect to each channel link between the plurality of transmission nodes and the node to be positioned based on preliminary positioning information estimated before performing positioning with respect to the node to be positioned and positioning information obtained by performing positioning with respect to the node to be positioned, and generating reliability information for each channel link between the plurality of transmission nodes and the node to be positioned based on the calculated error.

Here, the calculating may include calculating the error based on distance information between the plurality of transmission nodes and the node to be positioned which is estimated based on the signals transmitted from the plurality of transmission nodes before performing positioning with respect to the node to be positioned, and distance information between the plurality of transmission nodes and the node to be positioned which is acquired by performing positioning with respect to the node to be positioned.

Here, the again performing of the positioning may include generating a weight value equivalent to the reliability of each channel link, again performing positioning with respect to the node to be positioned by applying the generated weight value, updating the reliability of each channel link between the plurality of transmission nodes and the node to be positioned based on positioning information of the node to be positioned, the positioning information being acquired by again performing positioning by applying the generated weight value and again performing positioning based on the positioning information acquired by applying the weight value and the updated reliability and again performing positioning, when the predetermined positioning completion condition is not satisfied.

Here, the again performing of the positioning by applying the generated weighing value may include generating a plurality of circles having a distance between an actual position of each of the plurality of transmission nodes and the node to be positioned as a radius, acquiring a position of a point in which a straight extension line connecting a center of the plurality of transmission modes and a position of the node to be positioned intersects each of the plurality of circles, and calculating a position of the node to be positioned by applying the weight value to the acquired plurality of positions of the points.

Here, the performing of the positioning may include configuring a universal set including the plurality of transmission nodes, estimating distance information or angle information between the plurality of transmission nodes included in the universal set and the node to be positioned, and determining a position of the node to be positioned based on the estimated distance or angle information.

In other example embodiments, a positioning apparatus includes: a communication unit that receives positioning support information from a node to be positioned; and a positioning unit that generates reliability information for a channel link between a plurality of transmission nodes whose positions are learned in advance and the node to be positioned, based on the positioning support information, and again performs positioning with respect to the node to be positioned based on position information of the node to be positioned that is acquired by performing positioning and the reliability information when a predetermined positioning completion condition is not satisfied.

Here, the positioning support information may include at least one of distance or angle information between each of the plurality of transmission nodes and the node to be positioned, delay diffusion information, and received signal strength information.

In other example embodiments, a positioning apparatus includes: a communication unit that receives signals transmitted from a plurality of transmission nodes; and a positioning unit that performs positioning with respect to the positioning apparatus based on the signals transmitted from the plurality of transmission nodes, generates reliability information for a channel link with each of the plurality of transmission nodes, and then again performs positioning based on positioning information acquired by performing positioning and the reliability when a predetermined positioning completion condition is not satisfied.

As described above, according to the positioning method and apparatus, transmission nodes to be used for positioning may be selected and subsets may be configured, and then positioning with respect to each of the configured subset may be performed to thereby calculate a channel link error between each of the transmission nodes and a reception node. Next, each channel link may be provided with a reliability using the calculated error, the positioning may be again performed by applying a weight value equivalent to the reliability to each channel link, and then this process may be again performed.

Accordingly, it is possible to accurately determine the reliability of the channel link, thereby improving positioning performance.

### BRIEF DESCRIPTION OF DRAWINGS

The above and other objects, features and advantages of the present invention will become more apparent by describing in detail example embodiments of the present invention with reference to the accompanying drawings, in which:

FIG. 1 is a flowchart showing a positioning method according to an embodiment of the present invention;

FIG. 2 is a conceptual diagram for describing a positioning method using TOA;

FIG. 3 is a drawing showing an error of each link that is calculated in a positioning process according to an embodiment of the present invention;

FIG. 4 is a conceptual diagram for describing a weight value positioning method that is applied to a positioning method according to an embodiment of the present invention;

FIGS. 5A and 5B are drawings showing a positioning method and a network apparatus performing the positioning method according to an embodiment of the present invention; and

FIGS. 6A and 6B are drawings showing a positioning method and a configuration of a node to be positioned that performs the positioning method according to another embodiment of the present invention.

### DESCRIPTION OF EXAMPLE EMBODIMENTS

Example embodiments of the present invention are disclosed herein. Specific structural and functional details are merely representative, for the purpose of enabling those of ordinary skill in the art to embody present invention. The example embodiments of the present invention may be embodied in many alternate forms and should not be construed as limited to the following disclosure.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be to interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise” It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, preferred embodiments of the present invention will be described in detail with reference to the accompanying drawings.

Wireless positioning may be classified into uplink positioning and downlink positioning according to a subject to perform measurement. In general, in most cases, a node whose position is learned in advance may be fixed like a base station or the like, and a node to be positioned may be a mobile terminal. A case in which the node whose position is learned in advance is a transmission node and the node to be positioned is a reception node may refer to the downlink positioning, and a case in which the node to be positioned is a transmission node and the node whose position is learned in advance is a reception node may refer to the uplink positioning.

A positioning method according to an embodiment of the present invention may be applicable to both the uplink and the downlink.

In the case of downlink positioning, a reception node to be positioned may acquire radio wave information associated with positioning from a plurality of transmission nodes, and directly perform position calculation or transmit information required for the calculation to a transmission node, so that the transmission node may perform position calculation of the reception node to be positioned.

In the case of uplink positioning, reception nodes whose positions are learned in advance may acquire radio wave information associated with positioning from a transmission node to be positioned, and directly perform position calculation of the transmission node to be positioned or provide information to the transmission node, so that the transmission node to be positioned may directly perform its own position calculation.

Downlink positioning and uplink positioning may be similar to each other in terms of acquisition of radio wave information and position calculation at the time of wireless positioning, and therefore, for convenience of description, the positioning method according to an embodiment of the present invention will be described focusing on downlink positioning. However, the positioning method according to an embodiment of the present invention is not limited to downlink positioning, and may be applied equally to uplink positioning.

A wireless positioning process based on a mobile communication network may mainly comprise the following three steps.

In a first step, transmission nodes to be used for wireless positioning may be selected. In a second step, a distance (or a relative distance, an angle, delay diffusion, received signal strength, or the like) between the transmission node and a reception node may be estimated.

In a third step, a position of the reception node may be determined using the estimated distance.

In the positioning method according to an embodiment of the present invention, a method of regulating reliability of each channel link between a plurality of transmission nodes and a node to be positioned may be added. Therefore, a turbo-type wireless positioning method of again performing wireless positioning in such a manner that the reliability of each channel link is calculated, and a weight value equivalent to the reliability of each channel link is applied to each channel link may be provided, thereby improving positioning accuracy.

That is, the positioning method according to an embodiment of the present invention may be composed of the turbo-type wireless positioning method in which a process of calculating a position of a node to be positioned and a process of reliability of each channel line are again performed in such a manner that a position of the node to be positioned is calculated based on the reliability of each channel link between each of the plurality of transmission nodes and the node to be positioned in the process of calculating the position of the node to be positioned, and then the reliability of each channel link is again calculated to thereby apply the again calculated reliability to the process of calculating the position of the node to be positioned.

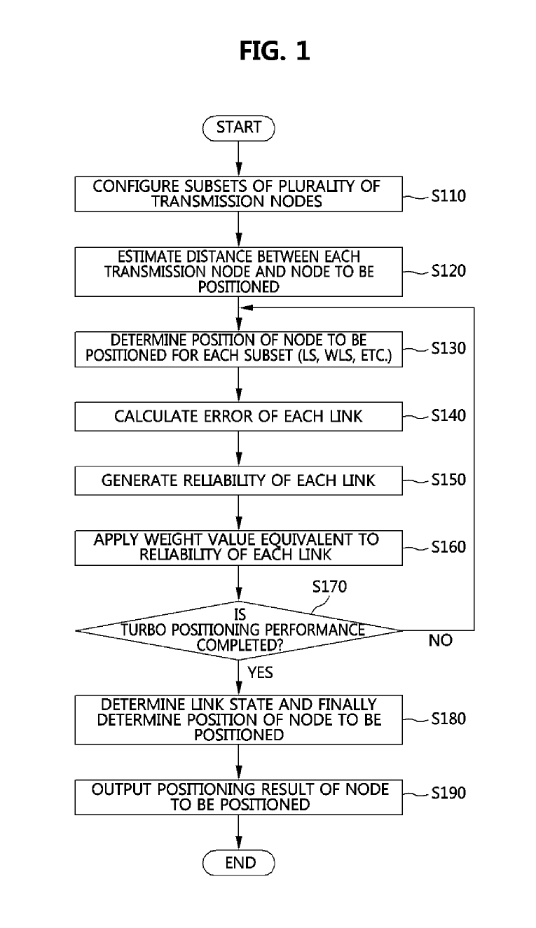

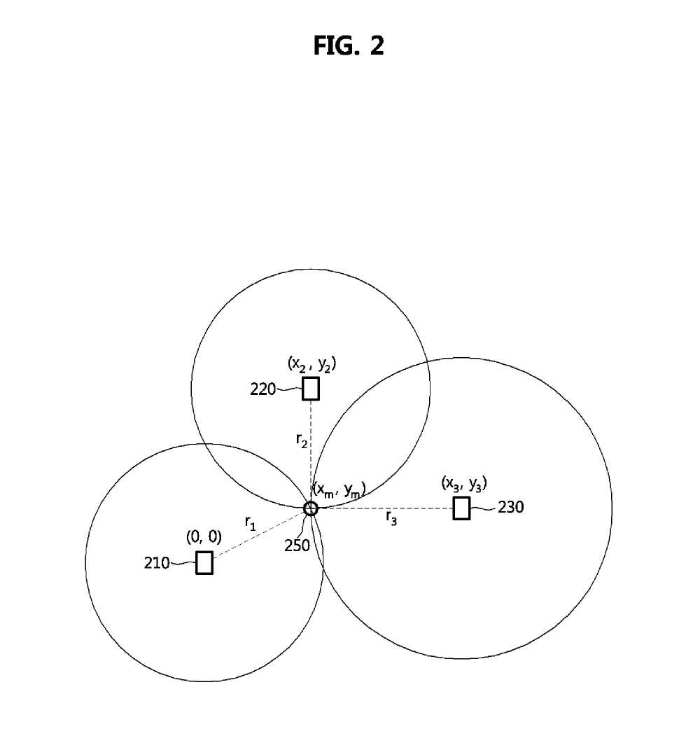

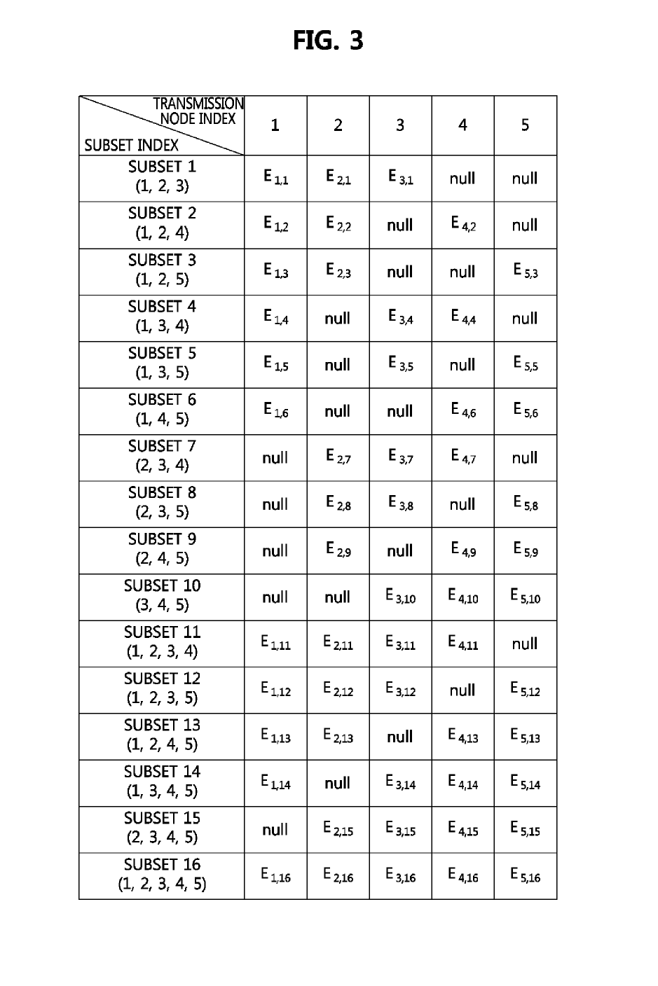

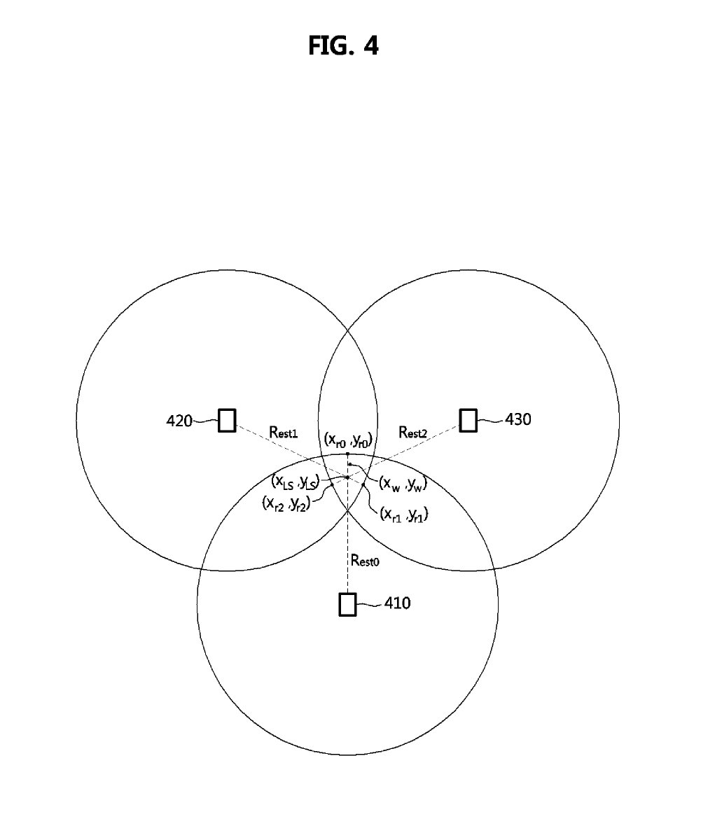

FIG. 1 is a flowchart showing a positioning method according to an embodiment of the present invention, FIG. 2 is a conceptual diagram for describing a positioning method using TOA, FIG. 3 is a drawing showing an error of each link that is calculated in a positioning process according to an embodiment of the present invention, and FIG. 4 is a conceptual diagram for describing a weight value positioning method that is applied to a positioning method according to an embodiment of the present invention.

The positioning method according to an embodiment of the present invention may generate subsets of the plurality of transmission nodes to which information for positioning is transmitted by a reception node, and may process a distance estimation value (or a relative distance, an angle, a delay diffusion value, a received signal strength, or the like) between each of the plurality of transmission nodes included in each subset before calculating positioning of the reception node and results obtained after calculating the positioning. That is, a link error may be calculated for each subset and for each link between each of the transmission nodes and the reception node, and link reliability with respect to each of the transmission nodes may be calculated based on the link error calculated. The turbo-type positioning method may again perform position calculation of the reception node in such a manner that positioning may be again performed with respect to a position of the reception node by applying a weight value equivalent to the obtained link reliability, the obtained result may be re-processed, and the link reliability may be updated to thereby again performing positioning, thereby improving positioning accuracy.

Hereinafter, referring to FIGS. 1 to 4, the positioning method according to an embodiment of the present invention will be described in more detail.

First, a node to be positioned may perform parameter setting and initialization as a preparation for positioning.

Next, in step S110, the node to be positioned may configure subsets of a plurality of transmission nodes for transmitting positioning signals.

In general, when the plurality of transmission nodes transmit the positioning signals, the node to be positioned may receive the positioning signals transmitted from the plurality of transmission nodes and then select the transmission nodes to be used for positioning. In general, at least three transmission nodes are required for two-dimensional (2D) wireless positioning, and at least four transmission nodes are required for three-dimensional (3D) wireless positioning. Here, the selection of the transmission node to be used for wireless positioning may be determined by a variety of criteria, and may be determined based on, for example, the strength of received signals.

In the positioning method according to an embodiment of the present invention, minimum transmission nodes or optimized transmission nodes may be selected for wireless positioning, and the transmission nodes selected for wireless positioning may be again configured in the form of subsets.

For example, when the number of transmission nodes selected for 2D wireless positioning is 5 (that is, {1, 2, 3, 4, 5}), at least three transmission nodes are required for 2D wireless positioning, and therefore a total of 16 transmission node subsets may be configured as shown below.

$$\begin{matrix}Five of a \\ total of five\end{matrix} \text{:} ( \begin{matrix}5 \\ 5\end{matrix} ) = 1 combination , \{ 12345 \}$$

$$\begin{matrix}Four of a \\ total of five\end{matrix} \text{:} ( \begin{matrix}5 \\ 4\end{matrix} ) = 5 combination , \{ 1234 \} \{ 1235 \} \{ 1245 \} \{ 1345 \} \{ 2345 \}$$

$$\begin{matrix}Three of a \\ total of five\end{matrix} \text{:} ( \begin{matrix}5 \\ 3\end{matrix} ) = 10 combination , \begin{matrix}\{ 123 \} \{ 145 \} \{ 124 \} \{ 234 \} \{ 125 \} \\ \{ 235 \} \{ 134 \} \{ \} 245 \{ 135 \} \{ 345 \}\end{matrix}$$

Next, in step S120, by applying a range-based positioning method to each subset of the transmission nodes configured as above, a distance (or an angle) between the transmission nodes included in each subset and the node to be positioned may be estimated. Here, as the range-based positioning method, a variety of well-known positioning methods may be used. For example, Time Of Arrival (TOA), Time Difference Of Arrival (TDOA), Angle Of Arrival (AOA), Delay Spread Of Arrival (DSOA), Received signal strength Of Arrival (ROA), or the like may be used.

In addition, in step S130, the distance between the transmission node and the node to be positioned may be estimated for each subset, and a position of the node to be positioned may be determined for each subset using the estimated distance. In order to determine the position of the node to be positioned, the position of the node to be positioned may be estimated by performing trilateration or triangulation using information such as the estimated distance (or angle) or the like, and as a method of determining the position, a method such as a least squares (LS) method may be used for initial positioning. In addition, in a turbo positioning process where positioning is again performed, a variety of methods such as a weighted least squares (WLS) method or the like using weight values may be used.

Meanwhile, in the positioning method according to an embodiment of the present invention, a positioning calculation method to which weight values are additionally applied may be required for the turbo-type position calculation.

As an example, with respect to all combinations of the transmission nodes, a position of the node to be positioned may be primarily estimated using the LS method.

Hereinafter, a TOA positioning method in which the distance between the transmission node and the node to be positioned may be estimated using TOA, and the position of the node to be positioned may be calculated through the LS method, will be described in more detail.

In the TOA positioning method, using a time required until signals transmitted from the transmission node arrive at the node to be positioned, the distance between the transmission node and the node to be positioned may be estimated. That is, since wireless signals have the speed of light (c=3×10⁸ m/c), the distance between each transmission node and the node to be positioned may be calculated as rᵢ=(tᵢ-t₀)c using an arrival time of the wireless signals. Here, tᵢ denotes a time required until the signals transmitted from the transmission node arrive at the node to be positioned, and t₀ denotes a point of time when the transmission node transmits signals. In order to estimate the distance using the transmission time tᵢ and the reception time t₀, absolute temporal synchronization between the transmission node and the node to be positioned may be required.

Referring to FIG. 2, when a position of a first transmission node 210 is (0, 0), a position of a second transmission node 220 is (x₂, y₂), a position of a third transmission node 230 is (x₃, y₃), a distance between the first transmission node 210 and a node 250 to be positioned is r₁, a distance between the second transmission node 220 and the node 250 to be positioned is r₂, and a distance between the third transmission node 230 and the node 250 to be positioned is r₃, three circles having radii of r₁, r₂, and r₃ may intersect at a single point (xₘ, yₘ), which is the ideal position of the node 250 to be positioned, but more than one intersection point may be generated by a channel error and an accuracy error, and a variety of methods may be used in order to determine (xₘ, yₘ).

First, using the distances r₁, r₂, and r₃ from the node 250 to be positioned to each of the transmission nodes 210, 220, and 230, the position (xₘ, yₘ) of the node 250 to be positioned may be calculated through the following Equations 1.

r₁²=xₘ²+yₘ²

r₂²=(x₂−xₘ)²+(y₂−yₘ)²

r₃²=(x₃−xₘ)²+(y₃−yₘ)² [Equations 1]

In Equations 1, it may be assumed that the distances between each of the transmission nodes 210, 220, and 230 and the node 250 to be positioned are r₁≦r₂≦r₃. In addition, in Equations 1, there are 2 unknowns and 3 equations, but the desired values xₘ and yₘ cannot be obtained only using Equations 1.

Accordingly, two simultaneous equations are obtained using three equations included in Equations 1 as shown in the following Equations 2, and therefore an estimated position of the node 250 to be positioned may be calculated using an LS method.

r₂²−r₁²=x₂²−2x₂xₘ+y₂²−2y₂yₘ

r₃²−r₁²=x₃²−2x₃xₘ+y₃²−2y₃yₘ [Equations 2]

Equations 2 may be expressed in the form of a determinant like the following Equation 3.

$$[ \begin{matrix}{x}_{2} & {y}_{2} \\ {x}_{3} & {y}_{3}\end{matrix} ] [ \begin{matrix}{x}_{m} \\ {y}_{m}\end{matrix} ] = \frac{1}{2} [ \begin{matrix}{K}_{2}^{2} - {r}_{2}^{2} + {r}_{1}^{2} \\ {K}_{3}^{2} - {r}_{3}^{2} + {r}_{1}^{2}\end{matrix} ] \qquad [ Equation 3 ]$$

In Equation 3, Kᵢ²=xᵢ²+yᵢ² is satisfied. In addition, in Equation 3, when

$$H = [ \begin{matrix}{x}_{2} & {y}_{2} \\ {x}_{3} & {y}_{3}\end{matrix} ] , \\ x = [ \begin{matrix}{x}_{m} \\ {y}_{m}\end{matrix} ] , \\ b = \frac{1}{2} [ \begin{matrix}{K}_{2}^{2} - {r}_{2}^{2} + {r}_{1}^{2} \\ {K}_{3}^{2} - {r}_{3}^{2} + {r}_{1}^{2}\end{matrix} ]$$

is satisfied, Equation 3 may be expressed as the following Equation 4.

Hx=b [Equation 4]

In Equation 4, x denotes a value to be estimated through positioning as position coordinates of the node 250 to be positioned, and H and b denote values that can be obtained through measurement. In order to estimate a value of x, a positioning value of the node to be positioned may be estimated using the LS method shown in Equation 5.

\hat{x}=(H^{T}H)⁻¹H^{T}b [Equation 5]

As described above, a preliminary positioning value of the node to be positioned may be primarily estimated using the TOA positioning method and LS method. Hereinafter, the position (xₘ, yₘ) of the node to be positioned that has been primarily estimated is referred to as (x_{LS}, y_{LS}).

Referring again to FIG. 1, in the positioning method according to an embodiment of the present invention, in step S140, a link error between each transmission node included in each subset and the node to be positioned may be calculated using an estimated position value of the node to be positioned that is obtained through preliminary positioning where a weight value has not yet been set like the above-described position estimation example.

The link error may be calculated using an estimated distance or angle from the signals transmitted from each transmission node before the positioning calculation of the node to be positioned, an estimated position of the node to be positioned after the positioning calculation, or a distance or angle calculated from a position of the transmission node.

For example, the distance between each transmission node and the node to be positioned may be calculated using TOA, and when the distance obtained by the signals transmitted from each transmission node before the positioning calculation is rᵢ and a geometric transmission and reception distance after the positioning calculation is ∥\hat{x}ⱼ−Xᵢ∥, an error of each link may be calculated using the following Equation 6.

Eᵢⱼ=f_{E}(|rᵢ,∥\hat{x}ⱼ−Xᵢ∥|) [Equation 6]

In Equation 6, i denotes an index of a transmission node, j denotes an index of a subset of each transmission node, and rᵢ denotes an estimated distance between the node to be positioned obtained through the transmission signals and the transmission node. In addition, \hat{x}ⱼ denotes a positioning value using transmission nodes included in an j-th subset, Xᵢ denotes a position of an i-th transmission node, and f_{E} denotes an error calculation function. Here, f_{E} may be given as a difference in absolute values of two elements as shown in Equation 6 when performing simple calculation, or given as another Equation or condition.

The above-described error calculation method is merely one example applied to the positioning method according to an embodiment of the present invention, and the present invention concerning the error calculation is not limited to a method of using the estimated distance obtained using radio waves before the positioning calculation and the geometric transmission and reception distance before the positioning calculation as described above. It should be understood that a method of generating an error according to an embodiment of the present invention includes all methods of generating an error through comparison before and after positioning calculation with respect to a single element.

FIG. 3 is a drawing showing an error of each link that is calculated in a positioning process according to an embodiment of the present invention. An error with respect to each link between the transmission nodes included in each subset and the node to be positioned may be obtained through Equation 6 as shown in FIG. 3. In an embodiment of the present invention, an example in which the link error for each subset of the transmission nodes is calculated as shown in FIG. 3 is shown, but according to other embodiments of the present invention, an error may be calculated only using a universal set that is different from the subset of the transmission nodes.

Referring again to FIG. 1, in step S150, errors of each channel link are obtained as described above, and then the reliability of a link between each transmission node and the node to be positioned is generated using the obtained errors.

Specifically, the reliability of each link may be generated by processing errors calculated from all subsets including each transmission node. For example, the reliability of each link may be generated using an average of reciprocals of the errors calculated from all subsets including each transmission node, a reciprocal of the average, or a reciprocal of a geometric average.

When a link error between each of five transmission nodes and a node to be positioned is as shown in FIG. 3, a total number of subsets including the first transmission node is 11 (that is, subsets 1, 2, 3, 4, 5, 6, 11, 12, 13, 14, and 16), and therefore a total of 11 link errors (E_{1,1}, E_{1,2}, E_{1,3}, E_{1,4}, E_{1,5}, E_{1,6}, E_{1,11}, E_{1,12}, E_{1,13}, E_{1,14}, E_{1,16}) may be calculated. The 11 link errors may be converted into link reliability between the transmission node 1 and the node to be positioned through processing. That is, link reliability Rᵢ with respect to an i-th transmission node may be calculated as shown in the following Equation 7.

Rᵢ=f_{R}({Eᵢⱼ|∀j,ith transmitting node εjth subset}) [Equation 7]

In Equation 7, f_{R} denotes a function for calculating reliability based on an error. Here, the reliability obtained through Equation 7 may be used to determine the presence or absence of line-of-sight (LOS) of each link, the transmission nodes having the highest link reliability may be selected, and only the selected transmission nodes may be used to perform positioning. In addition, in step s160, by applying a weight value equivalent to the obtained reliability to corresponding transmission nodes or each link, wireless positioning may be performed, thereby improving positioning accuracy. Here, when the error is calculated using the universal set different from the subsets of the transmission nodes, the error calculated using the universal set may be utilized as link reliability without any change, and may be as link reliability through separate processing.

Thereafter, in step S170, whether turbo positioning is completed is determined. Here, criteria for completing turbo positioning may be variously set, and for example, when repetition frequencies of the positioning, link error calculation, link reliability generation, and weight value applying process are set in advance, and a predetermined repetition frequency is satisfied, turbo positioning is deemed to be completed. In addition, when a change in the value of the link reliability is a predetermined reference value or less, or a specific number of transmission nodes that has been set in advance have a link reliability value of a predetermined threshold value or more, turbo positioning may be deemed completed.

When the turbo positioning completion condition is not satisfied, the method may return to step S 130, a position of the node to be positioned may be determined by performing weight value positioning calculation using the generated weight value, and then the following process may be again performed.

In the positioning method according to an embodiment of the present invention, wireless positioning may be performed using the link reliability value with respect to each transmission node as is, a weight value may be generated by processing the link reliability value (for example, a reciprocal of the reliability) with respect to each transmission node, and then weight value positioning calculation using the generated weight value may be performed, thereby improving positioning performance.

Referring to FIG. 4, through a position (x_{LS}, y_{LS}) of a node to be positioned that is primarily estimated without applying the weight value, and points where a straight extension connecting a center of each transmission node 410, 420, and 430 included in subsets of the transmission nodes and circumferences formed by each of the transmission nodes 410, 420 and 430 intersect each other, (xᵣᵢ, yᵣᵢ) may be obtained on each circumference.

Here, each circumference may be obtained by a distance estimated from signals transmitted by each of transmission nodes 410, 420, and 430 with an actual position (that is, a center of circle) of each transmission node.

As shown in FIG. 4, when the number of transmission nodes included in a predetermined subset is 3, three straight lines for connecting the center of each of the transmission nodes 410, 420, and 430 and the estimated position (x_{LS}, y_{LS}) of the node to be positioned may be obtained, and a total of points (xᵣᵢ, yᵣᵢ) where the three straight lines and a circumference of each of the transmission nodes 410, 420, and 430 may be 3. Here, when a position of the node to be positioned to which the weight value is applied is calculated by a weighted average of (Xᵣᵢ, Yᵣᵢ) using weight values using link reliability with respect to a channel between each of the transmission nodes 410, 420, and 430 and the node to be positioned, (x_{w}, y_{w}) may be obtained. In this instance, the weighted average may be normalized so that a sum of regulated weight values obtained by regulating weight values is 1.

As described above, when the link reliability may be obtained through weight value positioning calculation, and then the following process is performed, the link error may be updated by Equation 6, and therefore the link reliability may be updated.

Thereafter, the weight value positioning calculation may be again performed using the link reliability that is continuously updated, and positioning performance of the node to be positioned may be improved by the repeated turbo-type in which the link error and reliability are again updated.

When performing the weight value positioning calculation using the updated link reliability, each straight line may pass through the center of each transmission node and (x_{w}, y_{w}) that is the result of the previous weight value positioning calculation, or may pass through the center of each transmission node and (x_{LS}, y_{LS}) that is the result of the primary positioning estimation of the node to be positioned.

Meanwhile, as another example of performing the weight value positioning calculation, a WLS method may be used. When the WLS method is expressed using a TOA method, a WLS equation is generated as shown in the following Equation 8 by applying a weight value to Equation 3, and then a position of the node to be positioned may be estimated using Equation 5.

$$[ \begin{matrix}{x}_{2} & {y}_{2} \\ {x}_{3} & {y}_{3}\end{matrix} ] [ \begin{matrix}{x}_{m} \\ {y}_{m}\end{matrix} ] = \frac{1}{2} [ \begin{matrix}{a}_{1} ( {K}_{2}^{2} - {r}_{2}^{2} + {r}_{1}^{2} ) \\ {a}_{2} ( {K}_{3}^{2} - {r}_{3}^{2} + {r}_{1}^{2} )\end{matrix} ] \qquad [ Equation 8 ]$$

In Equation 8, aᵢ denotes a weight value, and when aᵢ is set as 1, the above-described WLS may be obtained.

Meanwhile, when the completion condition of the turbo positioning is satisfied based on the result determined through step S170, the position of the node to be positioned may be finally determined by determining a link state (LOS or Non-LOS) and/or selecting or processing positioning results of subsets of the transmission node in step S 180, and then the determined position value may be output in step S190.

As described above, in the positioning method according to an embodiment of the present invention, all of the transmission nodes that can be used for wireless positioning may be configured in the form of subsets, a position of the node to be positioned may be estimated by performing preliminary positioning with respect to each subset, a link error with respect to a channel between each transmission node and the node to be positioned may be obtained by processing an estimated distance obtained from radio waves before positioning calculation and a geometric distance obtained after the positioning calculation, link reliability may be obtained from the errors, and then the link reliability may be used as selection criteria of the transmission node to be used in the link state determination and positioning, or the turbo-type positioning process may be configured to thereby improve positioning performance.

In addition, the link reliability may be obtained even when using the universal set of the transmission node that is different from the subsets f the transmission node.

However, the above-described positioning method is merely an example for describing the turbo-type positioning method using the link reliability, and the present invention is not limited thereto. In particular, as the weight value positioning calculation method that performs positioning using the weight value, a variety of methods other than the above-described method may be adopted, and as the method of generating the link error and the reliability, a variety of methods may be also adopted. That is, the present invention may include all methods in which a link error between a plurality of transmission nodes whose position information is learned in advance and a node to be positioned may be processed as link reliability and/or weight value, and the processed link error may be used in positioning.

Meanwhile, the positioning method according to an embodiment of the present invention shown in FIG. 1 may require message flow for information transmission between nodes in accordance with an object for performing positioning among transmission nodes and a node to be positioned.

For example, in the downlink positioning, when a reception node to be positioned directly performs even its own position calculation from received signals, only final position information may be transmitted to the transmission node, and the process may be omitted, as necessary. However, when position calculation is performed in a network (transmission node or base station) for complex and precise calculation, the reception node should transmit information acquired from the received signals to the network.

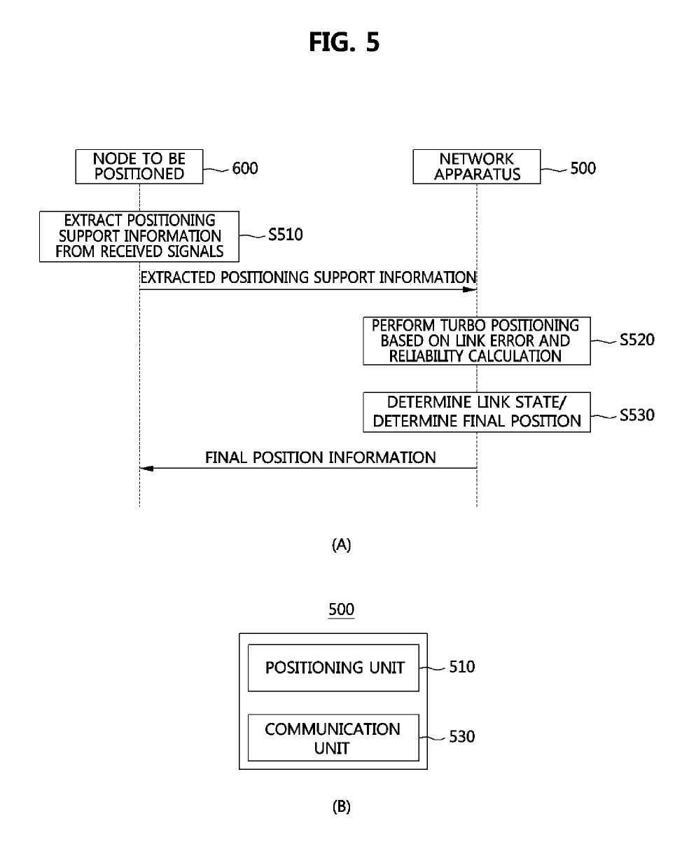

FIGS. 5A and 5B are drawings showing a positioning method and a network apparatus performing the positioning method according to an embodiment of the present invention. Here, FIG. 5A shows message flow when performing a turbo positioning method in a network, and FIG. 5B shows a schematic configuration of a network apparatus 500 that performs a turbo positioning method.

Referring to FIGS. 5A and 5B, in step S510, a node 600 to be positioned may extract positioning support information for positioning from signals received from the network apparatus 500, and then transmit the extracted positioning support information to the network apparatus 500.

Here, the node 600 to be positioned may be, for example, a mobile terminal, and the network apparatus 500 may include a transmission node whose physical position information is learned in advance, such as a base station, a fixed relay node, or the like. Hereinafter, for convenience of description, the network apparatus 500 may be referred to as a transmission node 500.

The positioning support information transmitted from the node 600 to be positioned to the transmission node 500 may include a distance, a relative distance and an angle between each of a plurality of transmission nodes and a node to be positioned, delay diffusion information, received signal strength information, and the like.

A communication unit 530 of the transmission node 500 may receive the positioning support information transmitted from the node 600 to be positioned, and process the received positioning support information to thereby provide the processed positioning support information to a positioning unit 510.

In step S520, the positioning unit 510 may generate subsets (or universal set) with respect to a plurality of transmission nodes whose positions are learned in advance including the positioning unit 510 based on the received positioning support information, estimate a distance between the plurality of transmission nodes included in the subsets (or universal set) and the node 600 to be positioned, determine the position of the node 600 to be positioned for each subset using the estimated distance, calculate a link error between the plurality of transmission nodes including the positioning unit 510 and the node 600 to be positioned based on the received positioning information and the position information of the node to be positioned with reference to FIG. 1, generate link reliability based on the calculated link error, and then perform a turbo positioning process based on the generated link reliability.

Next, in step S520, the positioning unit 510 may generate link reliability based on the calculated link error, and then perform a turbo positioning process based on the generated link reliability.

Next, in step S530, the positioning unit 510 may determine a link state between the plurality of transmission nodes and the node 600 to be positioned based on the result obtained by performing the turbo positioning process, and calculate a final position of the node 600 to be positioned.

Here, the positioning unit 510 may determine the final position of the node 600 to be positioned and transmit the determined final position to the node 600 to be positioned through the communication unit 530, as necessary.

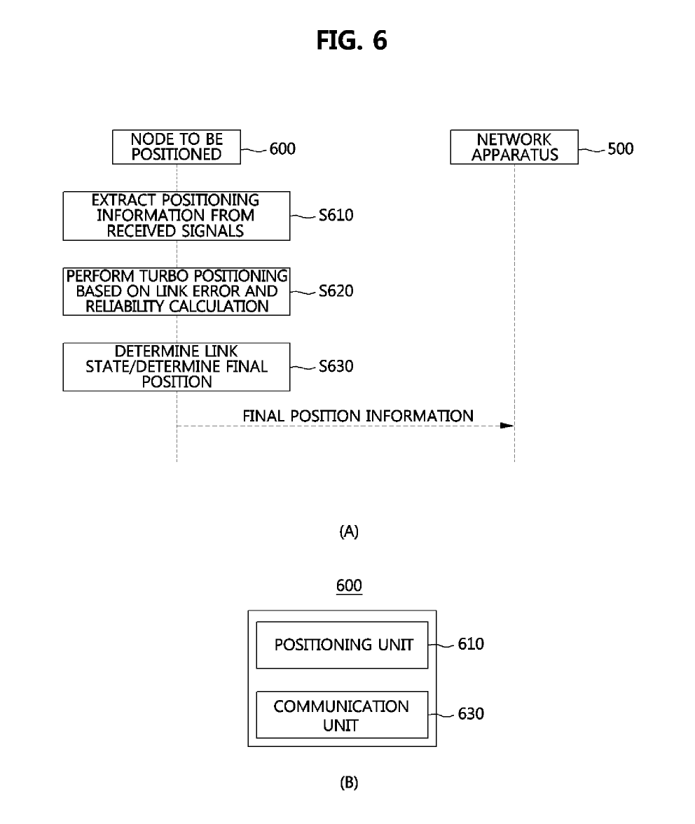

FIGS. 6A and 6B are drawings showing a positioning method and a configuration of a node to be positioned that performs the positioning method according to another embodiment of the present invention. Here, FIG. 6A shows message flow when the node 600 to be positioned performs the turbo positioning method, and FIG. 6B shows a schematic configuration of the node 600 to be positioned that performs the turbo positioning method.

In FIGS. 6A and 6B, the node 600 to be positioned may be, for example, a mobile terminal, and the network apparatus 500 may be a transmission node such as a base station, a fixed relay node, or the like.

Referring to FIG. 6, a communication unit 630 of the node 600 to be positioned may receive signals from a plurality of transmission nodes, process the received signals, and provide the processed signals to a positioning unit 610.

In step S610, the positioning unit 610 may extract information for positioning from the signals received from the plurality of transmission nodes. Here, the information for positioning may include a distance, a relative distance, and an angle between each of the plurality of transmission nodes and a node to be positioned, delay diffusion information, received signal strength information, and the like.

Next, in step S620, the positioning unit 610 may generate subsets (or a universal set) with respect to the plurality of transmission nodes, estimate a distance between the plurality of transmission nodes included in the subsets (or universal set) and the node 600 to be positioned, determine a position of the node 600 to be positioned for each subset (or universal set) using the estimated distance, calculate a link error between the plurality of transmission nodes and the node 600 to be positioned based on the preliminary positioning information estimated with reference to FIG. 1 as described above and the position information of the node 600 to be positioned, generate link reliability based on the calculated link error, and then perform a turbo positioning process based on the generated link reliability.

Next, in step S630, the positioning unit 610 of the node 600 to be positioned may determine a link state between the plurality of transmission nodes and the positioning unit 610 based on the result obtained by performing the turbo positioning process, and calculate a final position of the positioning unit 610.

Here, the positioning unit 610 may determine the final position, and then transmit the determined final position information to the transmission node 500 through the communication unit 630, as necessary.

While the example embodiments of the present invention and their advantages have been described in detail, it should be understood that various changes, substitutions and alterations may be made herein without departing from the scope of the invention.

What is claimed is:

1. A positioning method comprising:
performing positioning with respect to a node to be positioned based on signals transmitted from a plurality of transmission nodes;
generating reliability information for each channel link between the plurality of transmission nodes and the node to be positioned; and
again performing positioning with respect to the node to be positioned based on position information of the node to be positioned that is acquired by performing positioning and the reliability information when a predetermined positioning completion condition is not satisfied.

2. The positioning method of claim 1, wherein the performing of the positioning includes
generating at least one subset in accordance with predetermined criteria with respect to the plurality of transmission nodes,
estimating distance information or angle information between the plurality of transmission nodes included in each of the at least one subset and the node to be positioned, and
determining a position of the node to be positioned for each of the at least one subset based on the estimated distance or angle information.

3. The positioning method of claim 1, wherein the generating of the reliability information includes
calculating an error with respect to each channel link between the plurality of transmission nodes and the node to be positioned based on preliminary positioning information estimated before performing positioning with respect to the node to be positioned and positioning information obtained by performing positioning with respect to the node to be positioned, and
generating reliability information for each channel link between the plurality of transmission nodes and the node to be positioned based on the calculated error.

4. The positioning method of claim 3, wherein the calculating of the error includes calculating the error based on distance information between the plurality of transmission nodes and the node to be positioned which is estimated based on the signals transmitted from the plurality of transmission nodes before performing positioning with respect to the node to be positioned, and distance information between the plurality of transmission nodes and the node to be positioned which is acquired by performing positioning with respect to the node to be positioned.

5. The positioning method of claim 1, wherein the again performing of the positioning includes
generating a weight value equivalent to the reliability of each channel link,
again performing positioning with respect to the node to be positioned by applying the generated weight value,
updating the reliability of each channel link between the plurality of transmission nodes and the node to be positioned based on positioning information of the node to be positioned, the positioning information being acquired by again performing positioning by applying the generated weight value, and
again performing positioning again based on the positioning information acquired by again performing positioning by applying the weight value and the updated reliability when the predetermined positioning completion condition is not satisfied.

6. The positioning method of claim 5, wherein the again performing of the positioning by applying the generated weighing value includes
generating a plurality of circles having a distance between an actual position of each of the plurality of transmission nodes and the node to be positioned as a radius,
acquiring a position of a point in which a straight extension line connecting a center of the plurality of transmission modes and a position of the node to be positioned intersects each of the plurality of circles, and
calculating a position of the node to be positioned by applying the weight value to the acquired plurality of positions of the points.

7. The positioning method of claim 1, wherein the performing of the positioning includes
configuring a universal set including the plurality of transmission nodes,
estimating distance information or angle information between the plurality of transmission nodes included in the universal set and the node to be positioned, and
determining a position of the node to be positioned based on the estimated distance or angle information.

8. A positioning apparatus comprising:
a communication unit that receives positioning support information from a node to be positioned; and
a positioning unit that generates reliability information for a channel link between a plurality of transmission nodes whose positions are learned in advance and the node to be positioned, based on the positioning support information, and again performs positioning with respect to the node to be positioned based on position information of the node to be positioned that is acquired by performing positioning and the reliability information when a predetermined positioning completion condition is not satisfied.

9. The positioning apparatus of claim 8, wherein the positioning support information includes at least one of distance or angle information between each of the plurality of transmission nodes and the node to be positioned, delay diffusion information, and received signal strength information.

10. The positioning apparatus of claim 8, wherein the positioning unit generates at least one subset or a universal set in accordance with predetermined criteria with respect to the plurality of transmission nodes, estimates distance information or angle information between the plurality of transmission nodes included in the at least one generated subset or generated universal set and the node to be positioned, and then determines a position of the node to be positioned in units of the at least one subset or the universal set based on the estimated distance or angle information.

11. The positioning apparatus of claim 10, wherein the positioning unit calculates an error with respect to each channel link between the plurality of transmission nodes and the node to be positioned, and generates the reliability information for each channel link between the plurality of transmission nodes included in the at least one subset or the universal set and the node to be positioned based on the calculated error.

12. The positioning apparatus of claim 8, wherein the positioning unit generates a weight value equivalent to the reliability, again performs positioning with respect to the node to be positioned by applying the generated weight value, updates the reliability of each channel link between the plurality of transmission nodes and the node to be positioned based on positioning information of the node to be positioned, the positioning information being acquired by again performing positioning by applying the weight value and again performing positioning based on the positioning information acquired by applying the weight value and the updated reliability and again performing positioning, when the predetermined positioning completion condition is not satisfied.

13. A positioning apparatus comprising:
a communication unit that receives signals transmitted from a plurality of transmission nodes; and
a positioning unit that performs positioning with respect to the positioning apparatus based on the signals transmitted from the plurality of transmission nodes, generates reliability information for a channel link with each of the plurality of transmission nodes, and then again performs positioning based on positioning information acquired by performing positioning and the reliability when a predetermined positioning completion condition is not satisfied.

14. The positioning apparatus of claim 13, wherein the positioning unit generates at least one subset or a universal set in accordance with predetermined criteria with respect to the plurality of transmission nodes, estimates distance information or angle information with each of the plurality of transmission nodes included in the at least one generated subset or generated universal set, and then determines a position of the positioning apparatus in units of the at least one subset or the universal set based on the estimated distance or angle information.

15. The positioning apparatus of claim 14, wherein the positioning unit calculates a channel link error with respect to each of the plurality of transmission nodes, and generates the reliability information for the channel link between each of the plurality of transmission nodes included in the at least one subset or the universal set and the positioning apparatus based on the calculated error.

16. The positioning apparatus of claim 13, wherein the positioning unit generates a weight value equivalent to the reliability, again performs positioning with respect to the positioning apparatus by applying the generated weight value, updates the reliability of the channel link between each of the plurality of transmission nodes and the positioning apparatus based on positioning information acquired by again performing positioning by applying the generated weight value, and again performs positioning based on the positioning information acquired by applying the weight value and the updated reliability and again performing positioning, when the predetermined positioning completion condition is not satisfied.
